(19) United States
(12) Patent Application Publication
(10) Pub. No.: US 2012/0148854 A1
(43) Pub. Date: Jun. 14, 2012

(54) WIPING STAIN ALKYD RESIN COMPOSITION

(76) Inventor: Jeffrey Danneman, Raleigh, NC (US)

(21) Appl. No.: 13/303,233

(22) Filed: Nov. 23, 2011

Related U.S. Application Data
(60) Provisional application No. 61/420,824, filed on Dec. 8, 2010.

(51) Int. Cl. B32B 21/04; C09D 15/00

(52) U.S. Cl. 428/499; 106/34; 106/18; 428/498

(57) ABSTRACT

The present invention provides a wiping stain composition having an open time greater than 15 minutes. The wiping stain composition includes a liquid alkyd emulsion derived from the reaction of at least one unsaturated fatty acid (e.g., a synthetic or natural oil), and an acid or acid anhydride and polyhydric alcohol, a reactive diluent derived from an alkyl ester of a natural oil or fatty acid, and a pigment. Typically, the oil content is greater than about 45 percent by weight.

### CROSS-REFERENCE TO RELATED APPLICATIONS

This application claims the benefit of, and incorporates herein by reference in its entirety, the following U.S. Provisional Application: U.S. Provisional Application No. 61/420,824, filed Dec. 8, 2010.

### FIELD AND BACKGROUND OF THE INVENTION

The present invention relates to wiping stains and more particularly a wiping stain composition including an alkyd resin.

Wiping stains are applied to wood to impart a transparent color and to highlight the aesthetically pleasing aspects of the wood grain. Application is typically by rag, brush or spray. Typically the stain is applied and a predetermined amount of time is waited to allow the stain to penetrate the wood. After sufficient time and penetration, the remaining stain is removed with a rag. The stain is then further rubbed to accent features of the grain in the wood.

Where the stain is applied in sections of large parts, the various sections may be initially stained at different times. Where the stain overlaps in multiple sections, it is important that the stain colors of each of the sections be blended so that there are not obvious changes in color in the wood. The time between application of stain to a section of wood and the time the color can be blended with that of another wood section is referred to as “open time.” The longer the open time, the more flexibility the user will have in staining multiple sections.

For open time to be longer, the stain should remain fluid, low in viscosity, and easy to remove after long periods of standing. The stain must be tack-free soon after wiping, not wrinkle, lift or bleed when top-coated and not have a haze or milky look. Historically, stains having these properties were solvent-based materials. Such materials have become disfavored because the use of solvents are associated with high volatile organic compound (VOC) levels and the attendant pollution concerns. Alternatives include water-borne emulsion polymers that are low in VOCs. Such water-borne emulsion polymers; however, often have short open times. Several attempts to improve the open times of such emulsions have been reported. See, for example, U.S. Pat. Nos. 5,395,436 and 7,144,945 and U.S. Patent Publication No. 2010/0104884. There; however, remains a need for a wiping stain composition that has sufficient open time, is tack-free shortly after wiping, and does not adversely affect the properties of any post-application top coating.

### SUMMARY OF THE INVENTION

The present invention provides a wiping stain composition having an open time greater than 15 minutes. The wiping stain composition includes a liquid alkyd emulsion derived from the reaction of at least one unsaturated fatty acid (e.g., a synthetic or natural oil), and an acid or acid anhydride and polyhydric alcohol, a reactive diluent derived from an alkyl ester of a natural oil or fatty acid, and a pigment. Typically, the oil content is greater than about 45 percent by weight.

### DETAILED DESCRIPTION OF EMBODIMENTS OF THE INVENTION

The foregoing and other aspects of the present invention will now be described in more detail with respect to the description and methodologies provided herein. It should be appreciated that the invention can be embodied in different forms and should not be construed as limited to the embodiments set forth herein. Rather, these embodiments are provided so that this disclosure will be thorough and complete, and will fully convey the scope of the invention to those skilled in the art.

The terminology used in the description of the invention herein is for the purpose of describing particular embodiments only and is not intended to be limiting of the invention. As used in the description of the embodiments of the invention and the appended claims, the singular forms “a”, “an” and “the” are intended to include the plural forms as well, unless the context clearly indicates otherwise. Also, as used herein, “and/or” refers to and encompasses any and all possible combinations of one or more of the associated listed items. Furthermore, the term “about,” as used herein when referring to a measurable value such as an amount of a compound, dose, time, temperature, and the like, is meant to encompass variations of 20%, 10%, 5%, 1%, 0.5%, or even 0.1% of the specified amount.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise defined, all terms, including technical and scientific terms used in the description, have the same meaning as commonly understood by one of ordinary skill in the art to which this invention belongs.

The term “consists essentially of” (and grammatical variants), as applied to the methods in this invention, means the methods or compositions can contain additional steps as long as the additional steps or components do not materially alter the basic and novel characteristic(s) of the present invention.

The term “consisting of” excludes any additional step that is not specified in the claim.

Unless the context indicates otherwise, it is specifically intended that the various features of the invention described herein can be used in any combination.

Moreover, the present invention also contemplates that in some embodiments of the invention, any feature or combination of features set forth herein can be excluded or omitted.

All patents, patent applications and publications referred to herein are incorporated by reference in their entirety. In case of a conflict in terminology, the present specification is controlling.

As one of ordinary skill in the art may appreciate, the parameters described herein may vary greatly depending on the process, formulation and/or apparatus as well as the desired properties of the final product.

The present invention provides a wiping stain composition based on a liquid alkyd emulsion. The alkyd emulsion is derived from the reaction of an alcohol and an acid or an acid anhydride. In some embodiments, the alkyd resin includes an alkyd that is derived from at least one anhydride and at least one polyhydric alcohol, and is modified/reacted with a natural oil, synthetic oil, and/or fatty acid.

Suitable alkyd resins include those available from Reichhold Inc. under the tradename Beckosol® AQ, such as Beckosol® AQ 101 which is a “long oil alkyd” which refers to an alkyd having an oil content of greater than about 45% and Beckosol® AQ 101 is the reaction product of soy bean oil, phthalic anhydride and pentaerythritol.

The term “natural oil” refers to a triglyceride derived from a renewable resource, such as plant material. Exemplary natural oils include soy oil, corn oil, rapeseed oil, flax oil, castor oil, sunflower oil, tung oil, linseed oil, palm oil, cottonseed oil, canola oil, dehydrated castor oil, safflower oil, coconut oil, and the like, and blends thereof. Suitable fatty acids include oleic acid, linoleic acid, linolenic acid, recinoleic acid, lauric acid, myristic acid, stearic acid, palmitic acid, eicosanoic acid, eleostearic acid, and the like.

The acid and/or acid anhydride portion of the alkyd may be any diacid or monofunctional acid known in the art used in the formation of an alkyd resin. The dicarboxylic acid may be, for example, isophthalic acid, phthalic anhydride(acid), terephthalic acid, adipic acid, tetrachlorophthalic anhydride, dodecanedioic acid, sebacic acid, azelaic acid, 1,4-cyclohexanedicarboxylic acid, 1,3-cyclohexanedicarboxylic acid, maleic anhydride, fumaric acid, succinic anhydride, succinic acid, 2,6-naphthalenedicarboxylic acid, or glutaric acid and the like. In one embodiment, the dicarboxylic acid is isophthalic acid, phthalic anhydride, or phthalic acid. A monofunctional acid may also be used such as, for example, benzoic acid, acetic acid, propionic acid, and butanoic acid.

The polyhydric alcohol comprise alcohols having multiple hydroxyl groups per molecule including dihydric alcohols such as ethylene glycol, 1,2-propylene glycol, 2,3-butylene glycol, 1,4-butanediol, 1,5-pentanediol and 2,2-bis(4-hydroxycyclohexyl) propane; trihydric alcohols such as glycerine, 1,1,1-trimethylolethane, 1,1,1-trimethylolpropane, and 1,2,6-hexanetriol; tetrahydic alcohols such as erythritol, pentaerythritol and alpha-methyl glucoside; pentahydric and hexahydric alcohols such as tetramethylolcyclohexanol, dipentaerythritol, mannitol and sorbitol; polyallyl alcohol; and oxyalkylene adducts such as diethylene glycol, triethylene glycol and polyethylene glycol.

The reactive diluent is derived from an alkyl ester of a natural oil or a fatty acid. Exemplary natural oils and fatty acids are provided above. Exemplary alkyl esters include C₁-C₃ esters; glycol esters such as propylene glycol ester, ethylene glycol ester and trimethylol propane ester. The reactive diluents serves to lower the viscosity of the alkyd emulsion and thereby increase the open time.

The liquid alkyd emulsion may include nonionic and anionic surfactants. Any suitable nonionic surfactant may be used, such as polyoxyalkylene alkyl ethers, polyoxyalkylene alkylphenyl ethers, polyoxyalkylene fatty acid esters, polyoxyethylene-polyoxypropylene alkyl ethers, polyoxyalkylene alkylamines, glycerol fatty acid esters, higher fatty acid alkanolamides, alkylglycosides, alkylglucosamides, alkylamine oxides, ethylene oxides, and the like, and mixtures thereof.

Any suitable anionic surfactant may be used, such as a sodium alkyl aryl sulfonates, alkyl sulphonates, alkylpolyether sulphates, alkyl sulfates, fatty acid soaps, salts of hydrox-, hydroperoxy-, polyhydroxy-, epoxy-fatty acids, salts of mono- and polycarboxylic acids, alkyl phosphates, alkyl phosphonates, sodium-dialkyl sufosuccinate, n-alkyl ethoxylated sulfates, perfluorocarboxylic acids, fluoroacliphatic phosphonates, fluoroaliphatic sulphates, and mixtures thereof. In particular embodiments, the anionic surfactant includes sodium dodecyl benzene sulfonate.

The wiping stain composition includes a pigment to provide a stain or paint composition. Any suitable pigments may be used, including, but not limited to, bright pigments such as aluminum powder, copper powder, nickel powder, stainless steel powder, chromium powder, micaceous iron oxide, titanium dioxide-coated mica powder, iron oxide-coated mica powder and bright graphite; organic red pigments such as Pink EB, azo- and quinacridone-derived pigments; organic blue pigments such as cyanin blue and cyanin green; organic yellow pigments such as benzimidazolone-, isoindolin- and quinophthalone-derived pigments; inorganic colored pigments such as titanium white, titanium yellow, iron red, carbon black, chrome yellow, iron oxide, various calcined pigments, and mixtures thereof.

The invention accordingly includes a method of making an aqueous emulsion of a resin, particularly an alkyd resin, which comprises forming a mixture of the resin and surfactant in water to form a water in oil (resin) emulsion, and subsequently adding water to the water-in-oil emulsion at least until the emulsion inverts to form an oil (resin) in water emulsion and, optionally, adding further water to adjust the disperse phase content of the emulsion to that desired.

Generally, at least prior to the inversion to form an oil-in-water emulsion, the viscosity of the mixture is typically fairly high (reflecting the viscosity of the resin continuous phase) and to effect good mixing, the mixture will be stirred vigorously. Usually, after inversion, the stirring effort can be reduced because the viscosity falls substantially. (Also the mixing is not providing energy for substantial increase in net inter-phase surface area.)

The temperature at which the emulsion is prepared depends on the viscosity of liquid resins and the softening and/or melting point of solid resins and the properties of the softened and/or melted resin. Resins which are liquid at ambient temperature, such as many alkyd resins, are usually sufficiently viscous to make it inconvenient to carry out emulsification at temperatures as low as ambient. For such resins, the temperature of emulsification will be moderately superambient, typically up to about 75° C. e.g. in the range 30 to 75° C., particularly 40 to 60° C. and especially about 50° C. can be used.

Neutralizing agents may be included. For example, the alkyd resin may include ammonia, ammonium hydroxide, and primary, secondary and tertiary mono- or polyamines, including hydroxyamines, and especially the lower alkylamines, such as ethylamine, butylamine, dimethyl amine, diethyl amine, tributyl amine, triethyl amine, triisopropanolamine, ethanolamine, dimethylethanolamine, butanolamine, and the like. Amines which are volatile at temperatures below 350° F., preferably 250° F., are preferred. The amines can be added in undiluted form to give essentially anhydrous neutralized resin products, which products will be capable of practically unlimited dilution or dispersion in water without being coagulated. Alternatively, the resins can be neutralized by adding them to dilute aqueous solutions of water dispersible amines. Inorganic neutralizing agents, such as potassium or sodium hydroxide or carbonates can also be used. Mixtures of neutralizing agents can also be used.

If desired and depending on the intended use of the wiping stain composition, additional components may be added to the composition. These additional components include but are not limited to thickeners; rheology modifiers; dyes; sequestering agents; biocides; dispersants; extenders, such as, calcium carbonate, talc, clays, silicas and silicates; fillers, such as, glass or polymeric microspheres, quartz and sand; anti-freeze agents; plasticizers; drier metals; adhesion promoters; coalescents; wetting agents; waxes; surfactants; slip additives; crosslinking agents; defoamers; colorants; preservatives; freeze/thaw protectors, fungicides, corrosion inhibitors; and alkali or water soluble polymers.

The present invention will now be described in more detail with reference to the following examples. However, these examples are given for the purpose of illustration and are not to be construed as limiting the scope of the invention.

### Examples

Beckosol®AQ 101 was used without any reactive diluent (Control), with Oxy-Cure 1000 (propylene glycol ester of soy oil fatty acids available from Cargill) and Methyl Soyate (methyl ester of soy oil fatty acids available from Cargill). The reactive diluent was added slowly under good agitation and surprisingly migrated into micelles containing the liquid alkyd emulsion.

Open time was measured by the following:
Stain is rag or brush applied to an oak substrate in a 2″ stripe with the grain
This is allowed to stand 2 minutes
It is removed with a rag
At 5 minute intervals, a 2″ stripe of stain is rag applied perpendicular to the grain
This is allowed to stand for 2 minutes
It is removed with a rag and vigorous wiping
The stain is examined visually for lap marks
   The results are summarized in Table 1.

TABLE 1

| Formulation | Control | Oxy Cure 1000 | Methyl Soyate |
|---|---|---|---|
| Water | 284 | 283 | 282 |
| Thickener | 1.41 | 1.41 | 1.41 |
| Beckosol AQ 101 | 103 | 87.3 | 82.1 |
| Methyl Soyate | 0 | 0 | 11.3 |
| Oxy Cure 1000 | 0 | 8.47 | 0 |
| Colorant | 6 | 6 | 6 |
| Total Solids | 15% | 15% | 15% |
| Binder percent alkyd | 100 | 85 | 80 |
| Binder percent diluent | 0 | 15 | 20 |
| Open time | 5 minutes | 20 minutes | 15 minutes |

Having thus described certain embodiments of the present invention, it is to be understood that the invention defined by the appended claims is not to be limited by particular details set forth in the above description as many apparent variations thereof are possible without departing from the spirit or scope thereof as hereinafter claimed.

1. A wiping stain composition having an open time of greater than 15 minutes, said composition comprising:
a) a liquid alkyd emulsion derived from the reaction of at least one natural oil, synthetic oil, and/or fatty acid and an acid or acid anhydride and polyhydric alcohol, wherein the liquid alkyd emulsion has an oil content of greater than about 45 percent by weight;
b) a reactive diluent derived from an alkyl ester of a natural oil or fatty acid; and
c) a pigment.

2. The stain composition according to claim 1 further comprising one or more additives selected from the group consisting of surfactants, extenders, rheology modifiers, coalescents, wetting agents, viscosity control agents, pH controlling agents, biocides, fillers, UV stabilizers, drier metals, fungicides, and preservatives.

3. The stain composition according to claim 1, wherein the alkyd emulsion includes a natural oil.

4. The stain composition according to claim 3, wherein the natural oil comprises a plant triglyceride selected from the group consisting of soy oil, corn oil, rapeseed oil, flax oil, castor oil, sunflower oil, tung oil, linseed oil, palm oil, cottonseed oil, canola oil, dehydrated castor oil, safflower oil, coconut oil, and blends thereof.

5. The stain composition according to claim 1, wherein the acid anhydride is phthalic anhydride and the polyhydric alcohol is pentaerythritol.

6. The stain composition according to claim 1, wherein the reactive diluent derived from an alkyl ester of a natural oil is a propylene glycol ester of soy oil or a methyl ester of soy oil.

7. The stain composition according to claim 1, wherein the non-ionic surfactant is selected from the group consisting of polyoxyalkylene alkyl ethers, polyoxyalkylene alkylphenyl ethers, polyoxyalkylene fatty acid esters, polyoxyethylene-polyoxypropylene alkyl ethers, polyoxyalkylene alkylamines, glycerol fatty acid esters, higher fatty acid alkanolamides, alkylglycosides, alkylglucosamides, alkylamine oxides, ethylene oxides and the anionic surfactant is selected from the group consisting of a sodium alkyl aryl sulfonates, alkyl sulphonates, alkylpolyether sulphates, alkyl sulfates, fatty acid soaps, salts of hydrox-, hydroperoxy-, polyhydroxy-, epoxy-fatty acids, salts of mono- and polycarboxylic acids, alkyl phosphates, alkyl phosphonates, sodium-dialkyl sufosuccinate, n-alkyl ethoxylated sulfates, perfluorocarboxylic acids, fluoroacliphatic phosphonates, fluoroaliphatic sulphates, and mixtures thereof.

8. A substrate coated with the stain composition of claim 1.

9. The substrate according to claim 1, wherein the substrate comprises wood.

10. A substrate coated with the stain composition of claim 4.

11. The substrate according to claim 10, wherein the substrate comprises wood.
